(19) United States
(12) Patent Application Publication
(10) Pub. No.: US 2024/0324551 A1
(43) Pub. Date: Oct. 3, 2024

(54) HVAC REGISTER MOUNTED PET BED

(71) Applicant: Stephane Roy, Sudbury (CA)

(72) Inventor: Stephane Roy, Sudbury (CA)

(21) Appl. No.: 18/194,694

(22) Filed: Apr. 3, 2023

(51) Int. Cl. A01K 1/035

(52) U.S. Cl. CPC A01K 1/0353

(57) ABSTRACT

A pet bed that is configured to be operably coupled to a HVAC register located on a floor of a structure wherein the pet bed provides a suitable surface for a pet and further provides air flow from the register into the room. The present invention includes a support platform having an upper and lower surface wherein the support platform includes a register opening formed therein. A register mounting member extends downwards from the lower surface of the support platform into a HVAC register. The support platform has a multitude of air apertures formed therein. Angular support members are integrally formed around the entire perimeter of the support platform and includes a plurality of air apertures. Leg members are mounted to the lower surface of the support platform proximate the perimeter edge. A cushion member is superposed the upper surface of the support platform.

### FIELD OF THE INVENTION

The present invention relates generally to pet accessories, more specifically but not by way of limitation, a pet bed that is configured to be mounted over a floor mounted HVAC register wherein the present invention provides a temperature controlled surface for a pet and further allows distribution of air into the room.

### BACKGROUND

Heating and air conditioning are an essential part of maintaining a comfortable environment for a residential home. Conditioned air is distributed through a network of ducts to registers that are typically mounted in the ceiling or in the floor depending on the type of construction of the home. The registers that are mounted in the floor provide an airflow into the room that is at the desired temperature so as to adjust the room temperature to a temperature that has been set with a thermostat.

Many individuals who own homes also own pets such as but not limited to cats. Pets will often find a floor register especially during winter months and lay on top of the floor register as the air egressing therefrom provides a comfortable temperature for the animal. While some pet owners will place a pet bed adjacent to the floor register, often the pet will still lay on top of the register. This creates a need to perform routine maintenance on the register as pet hair will become clogged in the register and can further result in distribution of the pet hair to other areas in the room.

Accordingly, there is a need for a pet bed that is configured to be superposed a HVAC register mounted in a floor wherein the present invention provides a climate controlled surface for a pet and further ensures distribution of air to the room.

### SUMMARY OF THE INVENTION

It is the object of the present invention to provide a pet bed that is configured to be superposed a HVAC register mounted in the floor wherein the present invention includes a support platform having a lower surface and an upper surface.

Another object of the present invention is to provide an HVAC register mounted pet bed wherein the support platform of the present invention includes a plurality of apertures formed therein.

A further object of the present invention is to provide a pet bed that is configured to be superposed a HVAC register mounted in the floor wherein the lower surface of the support platform includes a register mounting member secured thereto extending downward therefrom.

Yet a further object of the present invention is to provide an HVAC register mounted pet bed wherein the perimeter edge of the support platform includes angular support member integrally formed therewith.

Still another object of the present invention is to provide a pet bed that is configured to be superposed a HVAC register mounted in the floor wherein the angular support members include a multitude of apertures formed therein.

An additional object of the present invention is to provide an HVAC register mounted pet bed wherein the upper surface of the support platform includes a cushion member secured thereto.

Yet a further object of the present invention is to provide a pet bed that is configured to be superposed a HVAC register mounted in the floor wherein the support platform further includes leg members secured to the lower surface thereof proximate the corners of the support platform.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top view of the support platform of the present invention; and

FIG. 2 is a side diagrammatic view of the present invention; and

FIG. 3 is a perspective view of the lower surface of the support platform.

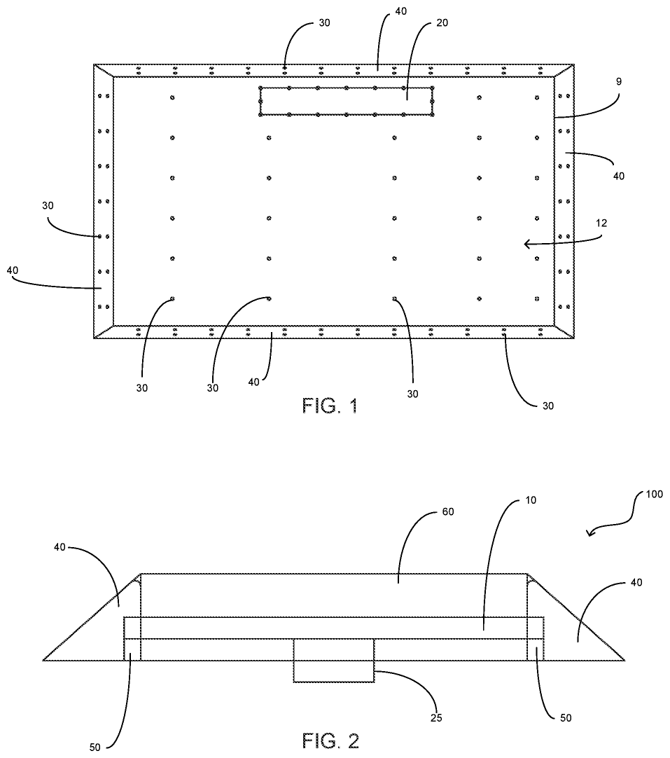

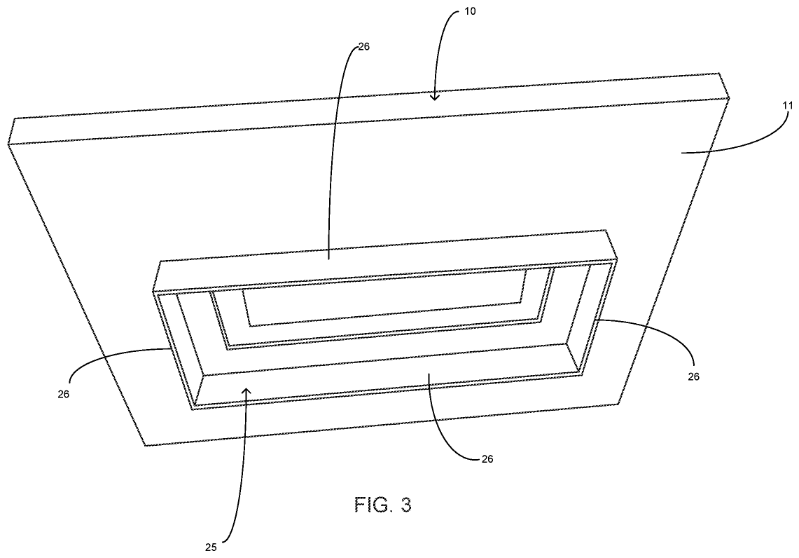

### DETAILED DESCRIPTION

Referring now to the drawings submitted herewith, wherein various elements depicted therein are not necessarily drawn to scale and wherein through the views and figures like elements are referenced with identical reference numerals, there is illustrated a pet bed 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to one “embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the pet bed 100 includes a support platform 10 wherein the support platform 10 is planar in manner having a lower surface 11 and an upper surface 12. The support platform is manufactured from a suitable rigid material such as but not limited to wood. In a preferred embodiment the support platform 10 is rectangular in shape but it should be understood within the scope of the present invention that the support platform 10 could be provided in alternate shapes and sizes.

Journaled through the support platform 10 is register opening 20. The register opening 20 is mateably sized and shaped to a conventional HVAC register that is present in the floor of a structure. The register opening 20 is formed completely through the support platform 10 and has operably coupled thereto a register mounting member 25. The register mounting member 25 is mounted around the perimeter of the register opening 20 and extends downward from the lower surface 11 of the support platform 10. The register mounting member 25 is configured to be journaled into a conventional HVAC air register and extend slightly thereinto so as to fluidly couple with the register. The register mounting member 25 includes four walls 26 integrally formed and is manufactured from a suitable rigid material such as but not limited to metal. It should be understood within the scope of the present invention that the walls 26 of the register mounting member 25 could be provided in alternate heights so as to extend into a HVAC register. Additionally, it should be understood that the register mounting member 25 could have alternate quantities of wall members so as to mateably couple to registers of different shapes. It should be further understood within the scope of the present invention that the register opening 20 can be formed in alternate locations on the support platform 10 so as to facilitate desired placement of the pet bed 100.

The support platform 10 further includes a multitude of air apertures 30. The air apertures 30 are formed through the support platform 10 and are annular in shape. The air apertures facilitate airflow through the support platform 10 across the entire surface area thereof. It should be understood within the scope of the present invention that the support platform 10 could have various quantities of air apertures 30 arranged in alternate patterns and be provided in different sizes.

Angular support members 40 are formed along the perimeter edge 9 of the support platform 10. The angular support members 40 extend around the entire perimeter of the support platform 10 and are mounted at an angle of forty-five degrees with respect to the support platform 10. The angular support members 40 provide a structure that inhibits walking interference with humans or animals as the angular support members 40 provide a transition with the floor on which the pet bed 100 is superposed that is at an angle that is less than ninety degrees. The angular support members 40 further include air apertures 30 so as to enable lateral air distribution outward from the support platform. Lateral air distribution from the air apertures 30 on the angular support platform 40 provides air flow to the room of the structure in which the pet bed 100 has been placed. Leg members 50 are secured to the lower surface 11 of the support platform 10. Leg members 50 are secured around the entire perimeter edge 9 of the support platform and are manufactured from a suitable rigid material such as but not limited to wood. In a preferred embodiment the leg members 50 are one-quarter inch in height so as to place the pet bed 100 in a low elevated position on the floor. It should be understood within the scope of the present invention that the leg members 50 could be provided in alternate heights.

The pet bed 100 includes a cushion member 60. The cushion member 60 is superposed the upper surface 12 of the support platform 10 and is equivalent in size thereto. The cushion member 60 is manufactured from a foam material that allows air to pass therethrough such as but not limited to memory foam. It should be understood within the scope of the present invention that the cushion member 60 could be provided in alternate thicknesses. The cushion member 60 is provided in a mateable shape to the support platform 10 so as to provide coverage of the upper surface 12 of the support platform 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A pet bed configured to be superposed a HVAC register located on a floor of a room wherein the pet bed comprises:
a support platform, said support platform having a lower surface and an upper surface, said support platform having a perimeter edge defining a shape thereof, said support platform having a register opening, said register opening being in axial alignment with the HVAC register, said support platform being manufactured from a rigid material;
a multitude of air apertures, said multitude of air apertures being formed through said support platform, said multitude of air apertures operable to permit airflow therethrough;
a register mounting member, said register mounting member having at least one wall, said register mounting member extending downward from said lower surface of said support platform, said register mounting member being mateably shaped with the HVAC register, said register mounting member operable to journal into the HVAC register; and
leg members, said leg members being mounted to said lower surface of said support platform, said leg members being proximate the perimeter edge of said support platform, said leg members configured to elevate the support platform above the floor over the HVAC register.

2. The pet bed configured to be superposed a HVAC register located on the floor of a room as recited in claim 1, and further including angular support members, said angular support members being formed along said perimeter edge of said support platform, said angular support members extending downward at an angle to the floor on which the pet bed is superposed.

3. The pet bed configured to be superposed a HVAC register located on the floor of a room as recited in claim 2, wherein the angular support members are oriented at a forty-five degree angle between the floor and said support platform.

4. The pet bed configured to be superposed a HVAC register located on the floor of a room as recited in claim 3, wherein the angular support members further include a plurality of air apertures, wherein the air apertures formed in the angular support members provide lateral airflow distribution outward from the pet bed.

5. The pet bed configured to be superposed a HVAC register located on the floor of a room as recited in claim 4, and further including a cushion member, said cushion member being mateably shaped to said support platform, said cushion member being superposed said upper surface of said support platform.

6. The pet bed configured to be superposed a HVAC register located on the floor of a room as recited in claim 5, wherein the leg members are one-quarter inch in height.

7. The pet bed configured to be superposed a HVAC register located on the floor of a room as recited in claim 6, wherein the support platform is manufactured from wood.
